(19) United States
(12) Patent Application Publication
(10) Pub. No.: US 2026/0254106 A1
(43) Pub. Date: Aug. 27, 2026

(54) BEACON FEEDBACK FOR ISOLATION OF CARRIER SIGNAL

(71) Applicant: The Charles Machine Works, Inc., Perry, OK (US)

(72) Inventors: Scott B. Cole, Edmond, OK (US); Klayton Day Jones, Perry, OK (US)

(21) Appl. No.: 19/548,027

(22) Filed: Feb. 24, 2026

Related U.S. Application Data
(60) Provisional application No. 63/762,852, filed on Feb. 25, 2025.

(51) Int. Cl. H01Q 1/44; E21B 47/0232

(52) U.S. Cl. CPC H01Q 1/44; E21B 47/0232

(57) ABSTRACT

An antenna circuit for a drilling system beacon. The circuit includes a carrier direct digital synthesizer (“DDS”) and a communication DDS that generate respective signals used to drive an antenna and produce a beacon signal having both carrier and communication components. To obtain an accurate indication of carrier amplitude for feedback control, the beacon signal is synchronously mixed with the carrier DDS signal using an analog switch or similar mixer. The resulting mixed signal contains sum and difference components that are passed through a lowpass filter to remove contributions from the communication component. The filtered output provides a direct current (“DC”) value representative only of the carrier amplitude, enabling a processor to regulate drive parameters without contamination from communication signals.

### SUMMARY

The present invention is directed to a downhole beacon system for use in a horizontal directional drilling operation. The system comprises a carrier signal generator, a communication signal generator, an antenna, a mixer, a filter, and a controller. The carrier signal generator is configured to produce a carrier signal. The communication signal generator is configured to produce a communication signal. The frequency of the communication signal is offset from the frequency of the carrier signal. The carrier signal and communication signal are combined to form a beacon output.

The antenna is configured to transmit the beacon output to an above-ground location, the beacon output having a carrier component and a communication component. The mixer is located in the downhole beacon and configured to mix the beacon output with the carrier signal to produce a mixed signal. A filter is configured to receive the mixed signal and remove the communication component and output a component indicative only of a carrier signal amplitude. The controller is configured to adjust at least one parameter of the carrier signal generator to maintain a consistent carrier signal amplitude.

In another embodiment, the invention is directed to a beacon antenna system. The system comprises a carrier signal generator, a communication signal generator, an antenna, a mixer, a filter, and a processor. The carrier signal generator is configured to generate a carrier signal. The communication signal generator is configured to generate a communication signal having a frequency that is offset from a frequency of the carrier signal.

The antenna is configured to transmit an alternating current antenna signal comprising a carrier component derived from the carrier signal and a communication component derived from the communication signal. The mixer is configured to receive the carrier signal and the alternating current antenna signal and to generate a mixed signal comprising components corresponding to sums and differences of the carrier signal and the alternating current antenna signal.

The filter is configured to remove components associated with the communication component from the mixed signal and produce a filtered feedback value representative of an amplitude of the carrier component. The processor is configured to adjust at least one drive parameter of the carrier signal generator based on the filtered feedback value.

In another aspect the invention is directed to a method of operating a beacon in a horizontal directional drilling operation. The method comprises generating a carrier signal for driving a magnetic dipole antenna of the downhole beacon, generating a communication signal, in which a frequency of the communication signal is offset from a frequency of the carrier signal, and combining the carrier signal and the communication signal to form a beacon output having a carrier component and a communication component.

The method then comprises transmitting the beacon output from the magnetic dipole antenna such that it is received at an above-ground location. Within the downhole beacon, the beacon output is mixed with the carrier signal to produce a mixed signal. The mixed signal is filtered to remove components associated with the communication component, and to output a filtered component indicative of substantially only an amplitude of the carrier component. At least one parameter of the carrier signal is then adjusted in response to the filtered component to maintain a consistent carrier signal amplitude.

### BRIEF DESCRIPTION OF THE DRAWINGS

FIG. 1 is a prior art drawing of a horizontal directional drilling operation that may be utilized with the novel feedback technique disclosed herein.

FIG. 2 is a block diagram of a typical feedback for a downhole transmitting antenna system capable of transmitting, simultaneously, a signal consisting of a carrier signal and a communication signal.

FIG. 3 is a graphical depiction of a signal amplitude from the antenna of FIG. 2.

FIG. 4 is a graphical depiction of the signal amplitude of FIG. 3, passed through a half wave rectifier.

FIG. 5 is the filtered signal amplitude of FIG. 4.

FIG. 6A is a block diagram of a downhole transmitting antenna system in accordance with the present invention capable of filtering the effects of a communication signal from a feedback signal.

FIG. 6B is a circuit diagram thereof, showing the antenna, mixer and filter.

FIG. 7 is a graphical depiction of a signal amplitude as passed through the mixer shown in FIGS. 6A-6B.

FIG. 8 is a graphical depiction of a signal amplitude after the signal of FIG. 7 is passed through a filter, providing a constant signal amplitude indicative of the carrier signal without the impacts of the communication signal.

### DETAILED DESCRIPTION

Beacons are used to determine characteristics of a borehole at an uphole location. In directional drilling applications, a drill string will advance through an underground environment to create a borehole. The borehole will be used for installation of a utility line. Examples of such beacon and tracking systems are provided in U.S. Pat. No. 7,331,409, issued to Cole, et. al., and U.S. Pat. No. 12,069,590, issued to Jones, et. al., the contents of which are incorporated by reference herein.

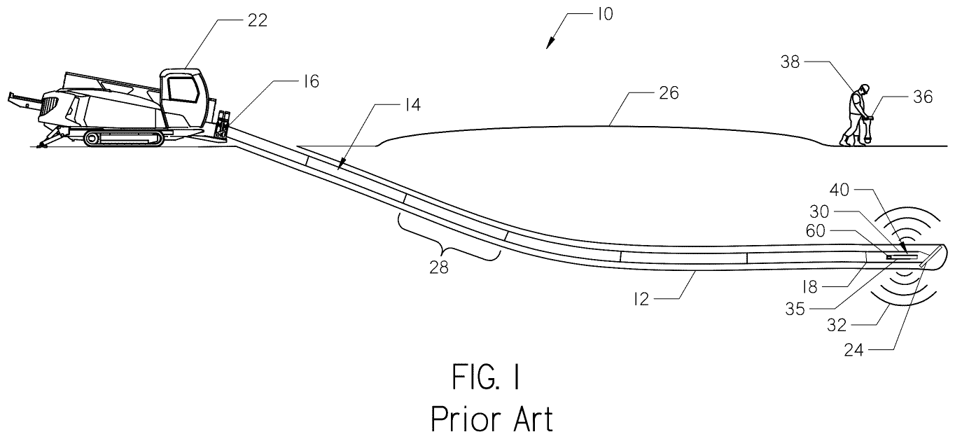

With reference to FIG. 1, a horizontal directional drilling system 10 is shown. The system 10 is used to create a borehole 12 under an above-ground obstacle, such as a roadway. The system 10 uses a drill string 14 having a first end 16 and a second end 18. The drill string 14 is attached to a drill rig 22 at its first end 16, and a drill bit 24 at its second end 18. The drill rig 22 is supported on a ground surface 26 and is operated by a rig operator. The drill string 14 comprises a plurality of hollow pipe sections 28 arranged in an end-to-end relationship. The drill string 14 functions to transmit thrust and rotation force from the drill rig 22 to the drill bit 24.

Continuing with FIG. 1, a downhole tool 30 is attached to the second end 18 of the drill string 14. The downhole tool 30 carries the drill bit 24 and houses a beacon 40. The beacon 40 is configured to emit a beacon signal 32 from the downhole tool 30 at a selected frequency. One or more beacon windows 35 may be formed in the downhole tool 30 for the beacon signal 32 to pass through. The beacon signal 32 is preferably a magnetic dipole field. The beacon 40 comprises an onboard antenna 60, which is controlled using components described herein.

An above-ground tracker 36, operated by a tracker operator 38, is used to detect and analyze the beacon signal 32 in order to determine a downhole position of the beacon 40. The beacon signal 32 includes information about the beacon 40 as well as the downhole conditions, such as the downhole temperature and fluid pressure. This additional information carried by the beacon signal 32 may be contained on a side frequency band, while the primary signal is received at the tracker 36 such that its shape can be analyzed to determine the position of the beacon 40. In operation, the tracker operator 38 walks along the planned borepath tracking the beacon signal 32 with the tracker 36.

Thus, beacon assemblies like the beacon 40 shown in FIG. 1 transmit an electromagnetic dipole carrier signal which can be detected at an above-ground location by receiving antennas within the tracker 36. The shape and magnitude of the signal 32 is used to determine the location and the depth of the beacon 40, which, in turn can allow accurate detection of the drill string 14 and mapping of a utility's path.

While the primary beacon signal, or “carrier” signal 32, is broadcast so that the tracker 36 can determine depth, other information may be transmitted by the beacon 40 on additional frequencies, referred to herein as “communication” frequency(ies). This information may include data about the beacon 40, such as its pitch and roll position, in addition to battery life, temperature, or any other data for which sensors may be included at the beacon 40.

The carrier signal 32 is continuously transmitted. Because this signal is the part of the transmission that the tracker 36 uses to locate and determine the depth of the beacon 40, it is very important that the carrier signal remain at the same level because the location and depth displayed on the above-ground tracker 36 will be incorrect otherwise.

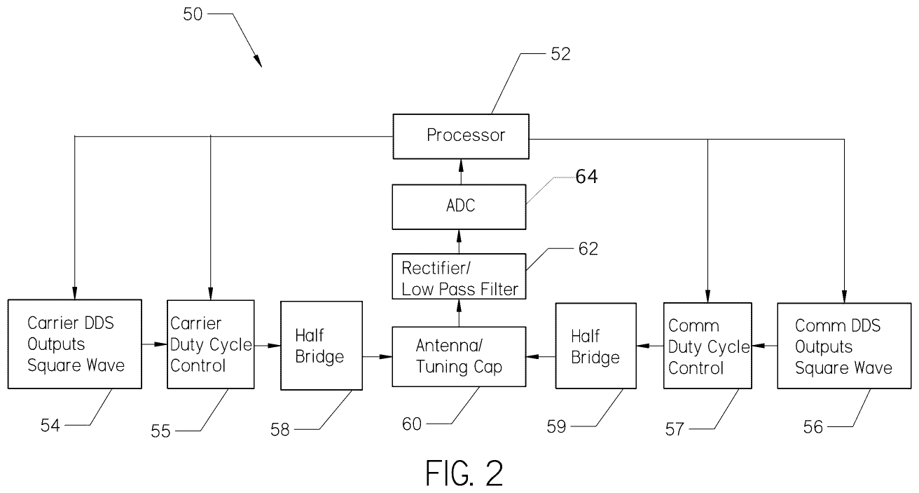

The communication frequency will change depending on the particular signal being sent and is always within 300 Hz of the carrier frequency—it can also be represented as the carrier frequency plus a communication frequency offset. The beacon 40 transmits these signals simultaneously using the circuit 50 shown in FIG. 2.

In the circuit 50, a processor 52 instructs a carrier direct digital synthesizer (“DDS”) 54 to generate, at 50% output, a duty cycle square wave at the carrier frequency, and the communication DDS 56 to generate, at 50% output, a duty cycle square wave at the selected communication frequency. These square waves are sent through independent duty cycle control circuits 55, 57 to alter their duty cycles from 50% to anywhere between 1% and 50% depending on instructions from the processor 52. These signals are then sent to a bridge circuit 58, 59 that drives the antenna 60. The antenna 60 generates a large alternating current (“AC”) signal comprised of the carrier signal 32 and the communication signal.

This AC signal is rectified and run through a low pass filter 62. The analog signal received at the filter 62 is converted to a digital signal at an analog-to-digital converter 64 and then read by the processor 52. If this feedback signal is lower than desired, the processor 52 may instruct the duty cycle control circuits 55, 57 to increase their respective duty cycles, which will result in a larger AC signal being generated by the antenna 60. If the feedback signal is higher than desired, the duty cycles are lowered.

The problem with this solution is that the carrier signal and communication signal are combined by the time the feedback circuit is read by the processor 52. In many cases, the component associated with the communication signal can “corrupt” the carrier level amplitude reading. It would be beneficial to eliminate the communication signal component from the feedback signal before it is read by the processor 52.

Eliminating the communication signal component could be done by using a digital signal processor or field-programmable gate array to filter the signal, but this solution is complicated, expensive, and power hungry. Because the beacon signal 32 is generated within the beacon 40 (FIG. 1) at the downhole position, which is sensitive to battery, space, and temperature limitations, a less power-intensive solution is necessitated.

In the below mathematical explanation, A is the amplitude of the carrier frequency-which becomes the “carrier component.” B is the amplitude of the communication frequency, and C is a known and constant DDS gating signal. ω_{c} is the carrier frequency, and ωₛ is the communication frequency.

In current antennas with this configuration shown in FIG. 2, a rectifier 62 followed by a low pass filter creates the feedback signal as follows:

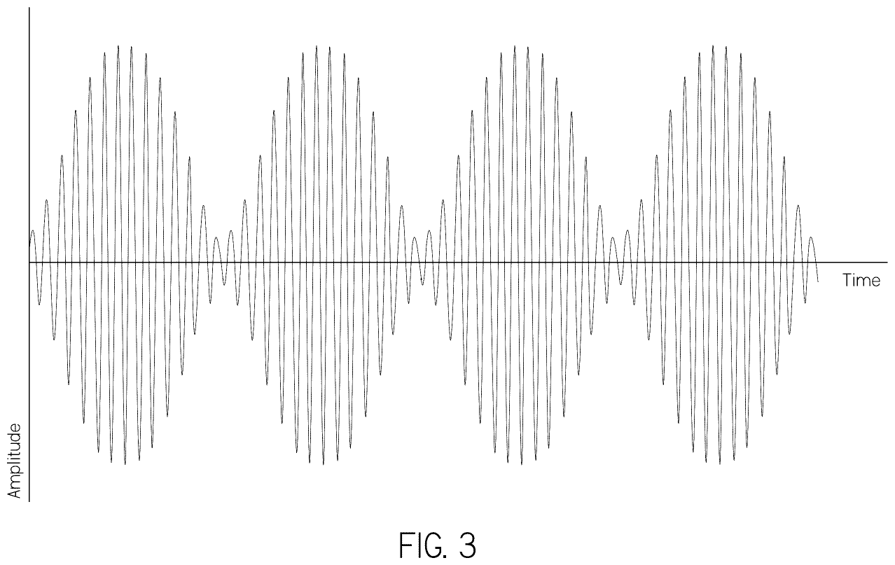

The signal coming from the antenna is: f(t)=A·cos (ω_{c}t)+B·cos (ωₛt). A graph of an amplitude of this signal is shown in FIG. 3.

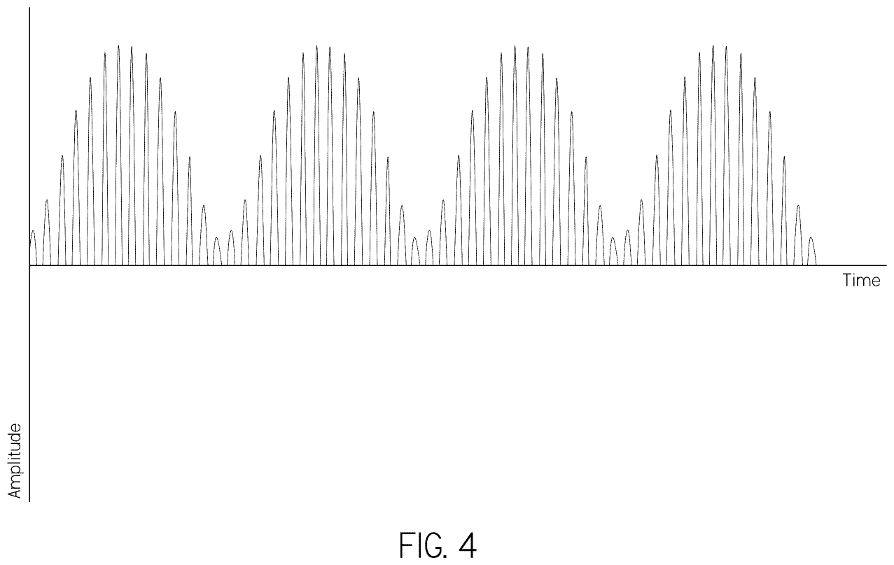

A diode creates a half wave rectifier which produces the following signal, as shown in FIG. 4.

$$f ( t ) = \frac{A}{π} + \frac{A}{2} \cdot sin ( {ω}_{c} t ) - {\sum }_{n = 2 , 4 , 6}^{∞} \frac{cos ( n \cdot {ω}_{c} t )}{( {n}^{2} - 1 )} + \frac{B}{π} + \frac{B}{2} \cdot sin ( {ω}_{s} t ) - {\sum }_{n = 2 , 4 , 6}^{∞} \frac{cos ( n \cdot {ω}_{s} t )}{( {n}^{2} - 1 )}$$

After the rectifier/low pass filter 62 is used to eliminate all sine and cosine terms:

$${f}_{fb\_lp} ( t ) = \frac{A}{π} + \frac{B}{π} .$$

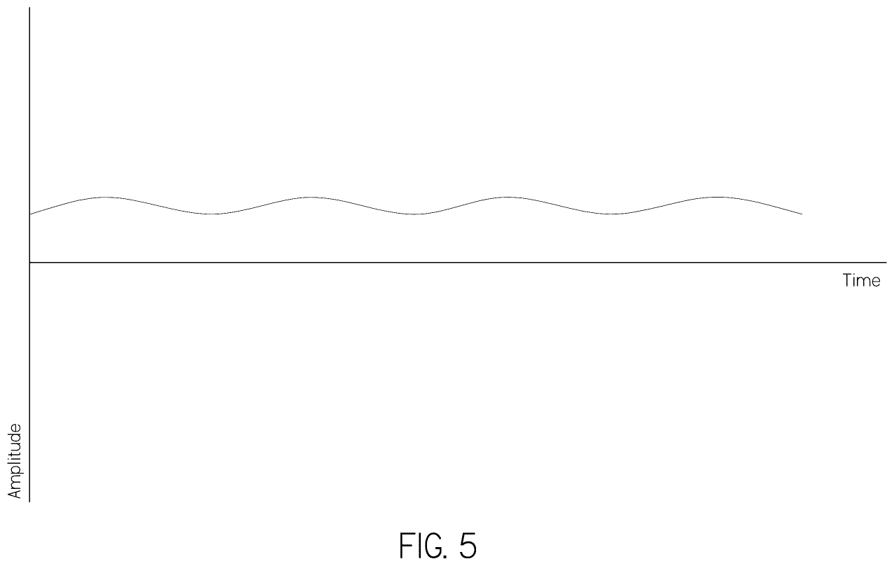

FIG. 5 snows unis graph, which reveals that B (the communication component) is still included in the feedback signal when a function with A as the only variable is desired.

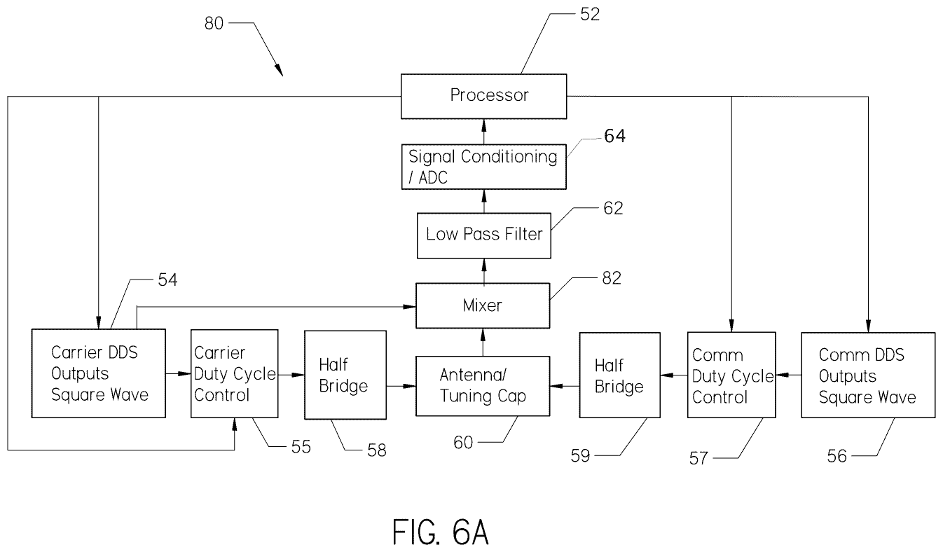

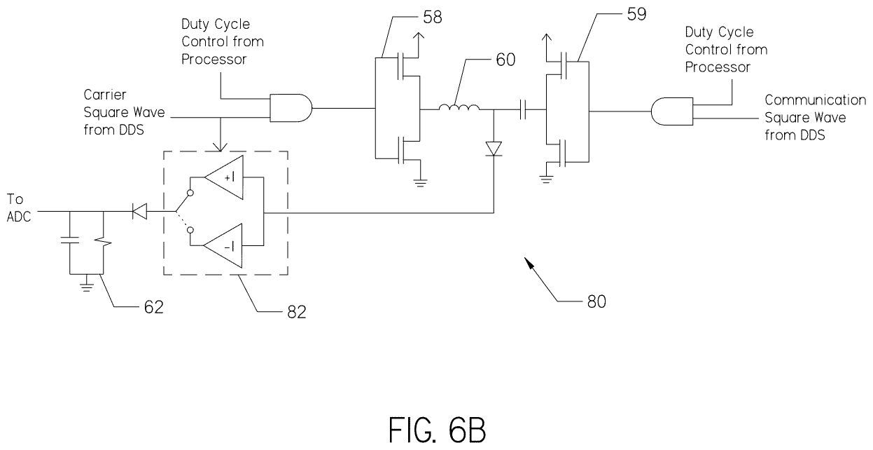

With reference to FIGS. 6A-6B, a solution to the problem shown above, with reference to FIGS. 2-5, is shown. In an alternative circuit 80 shown in FIGS. 6A-6B, the large AC signal produced at the antenna 60 is mixed with the carrier DDS signal. This can be done by gating an analog mixer 82 with the carrier DDS signal and allowing the chopped AC signal through to the rectifier/low pass filter 62.

Using the mixer 82 (typically, a switch), the signal oscillates between the sum and difference of the mixed signals. In this case, the output of the mixer 82 would be the carrier frequency plus the carrier frequency plus the communication frequency offset (up to 300 Hz) along with the carrier frequency minus the carrier frequency minus the communication signal offset.

Now, when the mixed signal is passed through the rectifier/low pass filter 62, all of the influence of the communication signal can be eliminated, leaving the direct current (“DC”) representation of the carrier portion of the large AC signal. This signal, alone, can be interpreted by the processor 52 for providing feedback control through the duty cycle control circuits 55, 57.

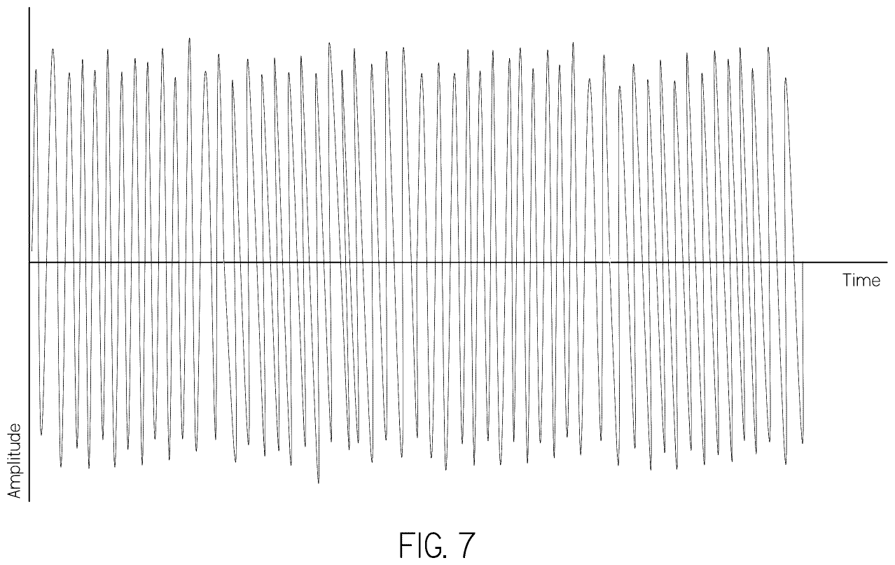

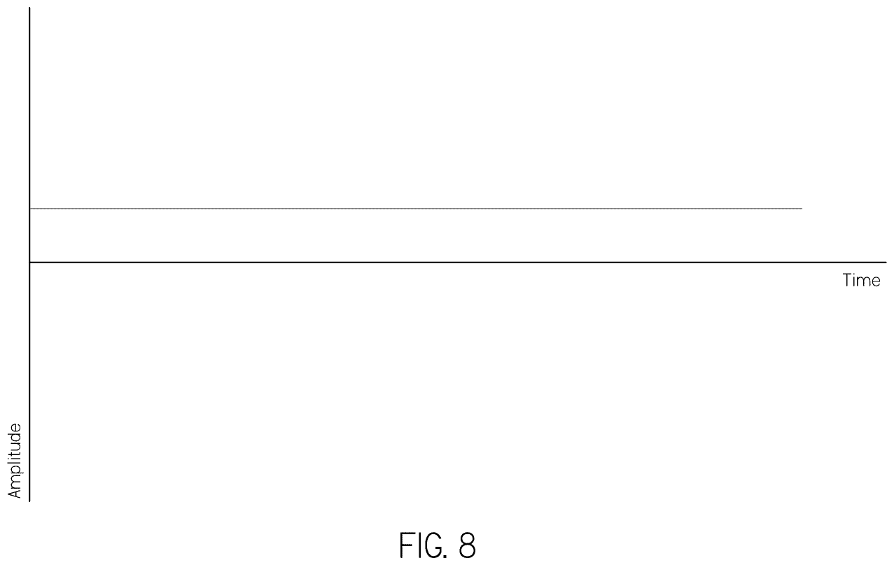

This advantage is shown by graphs in FIGS. 7-8. The signal coming from the antenna is: f(t)=A·cos (ω_{c}t)+B·cos (ωₛt)

The output of the mixer becomes: f_{fb}(t)=[A·cos (ω_{c}t)+B·cos (ωₛt)]·[C·cos (ω_{c}t)], with the output shown in FIG. 7.

### Simplifying:

$$\begin{matrix}{f}_{fb} ( t ) = AC \cdot cos ( {ω}_{c} t ) \cdot cos ( {ω}_{c} t ) + BC \cdot cos ( {ω}_{s} t ) \cdot cos ( {ω}_{c} t ) \\ {f}_{fb} ( t ) = \frac{AC}{2} \cdot cos ( {ω}_{c} t + {ω}_{c} t ) \cdot cos ( {ω}_{c} t - {ω}_{c} t ) + \frac{BC}{2} \cdot cos ( {ω}_{s} t + {ω}_{c} t ) \cdot cos ( {ω}_{s} t - {ω}_{c} t ) \\ {f}_{fb} ( t ) = AC \cdot [ \frac{cos ( {ω}_{c} t + {ω}_{c} t )}{2} + \frac{cos ( 0 )}{2} ] + BC \cdot [ \frac{cos ( {ω}_{s} t + {ω}_{c} t )}{2} + \frac{cos ( {ω}_{s} - {ω}_{c} t )}{2} ] \\ {f}_{fb} ( t ) = \frac{AC}{2} + \frac{BC}{2} \cdot cos ( {ω}_{s} t - {ω}_{c} t ) + \frac{AC}{2} \cdot cos ( 2 {ω}_{c} t ) + \frac{BC}{2} \cdot cos ( {ω}_{s} t + {ω}_{c} t )\end{matrix}$$

After the rectifier/low pass filter 62 with cutoff frequency, what remains is

$${ω}_{s} - {ω}_{c} : {f}_{fb\_lp} ( t ) = \frac{AC}{2} .$$

This relationship is shown in the plot of FIG. 8. As shown in FIG. 8, the processor 52 now receives a DC value that is solely representative of the amplitude of the carrier frequency and no influence from a communication frequency.

This DC value can thus be monitored such that should the amplitude vary from the desired value, adjustments can be made in the power level of the carrier signal by the processor 52 such that the amplitude remains constant, improving the accuracy of the drill string tracking operation by removing contamination from any or communication signal. This may be characterized as adjusting a drive parameter of the carrier signal, or parameters of the duty cycle control circuit 55.

The various features and alternative details of construction of the apparatuses described herein for the practice of the present technology will readily occur to the skilled artisan in view of the foregoing discussion, and it is to be understood that even though numerous characteristics and advantages of various embodiments of the present technology have been set forth in the foregoing description, together with details of the structure and function of various embodiments of the technology, this detailed description is illustrative only, and changes may be made in detail, especially in matters of structure and arrangements of parts within the principles of the present technology to the full extent indicated by the broad general meaning of the terms in which the appended claims are expressed.

1. A method of operating a downhole beacon in a horizontal directional drilling operation, the method comprising:
generating a carrier signal for driving a magnetic dipole antenna of the downhole beacon;
generating a communication signal, in which a frequency of the communication signal is offset from a frequency of the carrier signal;
combining the carrier signal and the communication signal to form a beacon output having a carrier component and a communication component;
transmitting the beacon output from the magnetic dipole antenna such that it is received at an above-ground location;
mixing the beacon output with the carrier signal within the downhole beacon to produce a mixed signal;
filtering the mixed signal to remove components associated with the communication component, and to output a filtered component indicative substantially only of an amplitude of the carrier component; and
adjusting at least one parameter of the carrier signal in response to the filtered component to maintain a consistent carrier signal amplitude.

2. The method of claim 1, wherein generating the carrier signal comprises operating a first direct digital synthesizer to produce the carrier signal at a substantially fixed carrier frequency.

3. The method of claim 2, wherein generating the communication signal comprises operating a second direct digital synthesizer to produce the communication signal at a frequency offset from the carrier frequency by less than about 300 Hz.

4. The method of claim 1, wherein mixing the beacon output with the carrier signal comprises gating an analog switch with the carrier signal to intermittently pass the beacon output and produce the mixed signal.

5. The method of claim 1, wherein adjusting at least one parameter of the carrier signal comprises changing a power level.

6. The method of claim 1, wherein transmitting the beacon output from the magnetic dipole antenna toward the above-ground location comprises transmitting a magnetic dipole field detectable by an above-ground tracker configured to determine a depth of the downhole beacon.

7. The method of claim 6, further comprising retrieving information from the communication signal at the above-ground tracker.

8. The method of claim 1, wherein the filtered component is a substantially direct-current signal proportional to the amplitude of the carrier component.

9. A beacon antenna system comprising:
a carrier signal generator configured to generate a carrier signal;
a communication signal generator configured to generate a communication signal, the communication signal having a frequency that is offset from a frequency of the carrier signal;
an antenna configured to produce an alternating current antenna signal comprising a carrier component derived from the carrier signal and a communication component derived from the communication signal;
a mixer, configured to receive the carrier signal and the alternating current antenna signal and to generate a mixed signal comprising components corresponding to sums and differences of the carrier signal and the alternating current antenna signal;
a filter configured remove components associated with the communication component from the mixed signal and produce a filtered feedback value representative of an amplitude of the carrier component; and
a processor configured to adjust at least one drive parameter of the carrier signal generator based on the filtered feedback value.

10. The beacon antenna system of claim 9, wherein the processor is configured to maintain the filtered feedback value within a predetermined range corresponding to a target carrier amplitude.

11. The beacon antenna system of claim 9, wherein the mixer comprises an analog switch.

12. A system comprising:
the beacon antenna system of claim 9; and
an above-ground tracker, the above-ground tracker comprising a receiving antenna configured to receive the alternating current antenna signal.

13. The system of claim 12, in which the above-ground tracker comprises a processor configured to determine a depth of the beacon antenna system using the carrier component of the alternating current antenna signal.

14. The beacon antenna system of claim 9, in which the antenna comprises a magnetic dipole antenna.

15. A downhole beacon system for use in a horizontal directional drilling operation, comprising:
a carrier signal generator configured to produce a carrier signal;
a communication signal generator configured to produce a communication signal, in which a frequency of the communication signal is offset from a frequency of the carrier signal and combined with the carrier signal to form a beacon output;
an antenna configured to transmit the beacon output to an above-ground location, the beacon output having a carrier component and a communication component;
a mixer located in the downhole beacon and configured to mix the beacon output with the carrier signal to produce a mixed signal;
a filter configured to receive the mixed signal and remove the communication component, and output a component indicative only of a carrier signal amplitude; and
a controller configured to adjust at least one parameter of the carrier signal generator to maintain a consistent carrier signal amplitude.

16. The downhole beacon system of claim 15, wherein the mixer comprises an analog switch configured to receive the beacon output and to be gated by the carrier signal to produce the mixed signal.

17. The downhole beacon system of claim 15, wherein the filter comprises a low pass filter configured to output a substantially direct current signal indicative only of the carrier signal amplitude.

18. The downhole beacon system of claim 15, wherein the beacon output comprises a magnetic dipole field detectable by an above-ground tracker configured to determine at least one of a position and a depth of the downhole beacon.

19. The downhole beacon system of claim 18, wherein the communication signal encodes telemetry data representative of one or more operating conditions of the downhole beacon.
